(19) United States
(12) Patent Application Publication
(10) Pub. No.: US 2007/0165419 A1
(43) Pub. Date: Jul. 19, 2007

(54) Spread illuminating apparatus having light reflecting sheet with light diffusing portions

(75) Inventors: Toshihiro Horiuchi, Kitasaku-gun (JP); Hitoshi Mizutani, Kitasaku-gun (JP)

Correspondence Address: OLIFF & BERRIDGE, PLC, P.O. BOX 19928, ALEXANDRIA, VA, 22320, US

(73) Assignee: Minebea Co., Ltd., Kitasaku-gun (JP)

(21) Appl. No.: 10/590,112

(22) PCT Filed: Aug. 27, 2004
(86) PCT No.: PCT/JP04/12391

§ 371 Date: Aug. 18, 2006

(30) Foreign Application Priority Data
Feb. 27, 2004 (JP) 2004-053959

(51) Int. Cl. F21V 7/04

(52) U.S. Cl. 362/606

(57) ABSTRACT

A spread illuminating apparatus is provided which includes: a light conductive plate having a light entrance surface and a light exit surface; a plurality of LEDs disposed at the light entrance surface of the light conductive plate; a light reflecting sheet disposed at the light exit surface so as to cover a portion of the light conductive plat located close to the side surface and also the LEDs, and a plurality of light diffusing portions disposed at the light reflecting sheet so as to cover respective LEDs. Lights leaking from the LEDs are diffused by the light diffusing portions thus preventing the brightness variation at the areas closed to the LEDs, and the leakage lights are reflected by the light reflecting sheet into the light conductive plate so as to be efficiently utilized thus achieving an enhanced brightness across the light exit surface of the light conductive plate.

### BACKGROUND OF THE INVENTION

1. Field of the Invention

The present invention relates to a spread illuminating apparatus of side light type, and particularly to a spread illuminating apparatus for use as an illumination means in a liquid crystal display device.

2. Description of the Related Art

A backlight device, which illuminates a liquid crystal display (LCD) from behind, has been developed as an illumination means for an LCD device. Such a backlight device typically includes a light conductive plate formed of a transparent material, and a plurality of light emitting diodes (LEDs) are disposed at a side surface of the light conductive plate or embedded in recesses formed at the side surface. Lights emitted from the LEDs and introduced into the light conductive plate from the side surface are reflected and diffused while propagating in the light conductive plate, and exit out the light conductive plate from one major surface (light exit surface) thereof. For enabling the lights to efficiently exit out from the light exit surface, a light reflecting plate is provided at the other major surface opposite to the light exit surface.

In the backlight device structured as above, more light exits out the light exit surface from areas positioned at the front direction of the LEDs, which makes those areas brighter than other areas (for example, between adjacent LEDs) thus generating an undesired brightness variation. In order to address this brightness vibration problem, a backlight device is disclosed in which a light reflecting and absorbing sheet consisting of light reflecting portions and light absorbing portions is disposed along the side of a light conductive plate such that the light absorbing portions cover respective LEDs (refer to Japanese Patent Application Laid-Open No. 2003-242817).

In the backlight device disclosed in the aforementioned Japanese Patent Application, the light absorbing portions of the light reflecting and absorbing sheet absorb lights at the areas in the front direction of the LEDs thereby lowering brightness at those areas so as to provide a uniform brightness across the light exit surface of the light conductive plate. This approach, however, achieves a uniform brightness by deteriorating the brightness at the areas close to the LEDs, and therefore the brightness is lowered as a whole.

### SUMMARY OF THE INVENTION

The present invention has been made in light of the above circumstances, and it is an object of the present invention to provide a spread illuminating apparatus which prevents brightness variation at the areas close to LEDs without lowering the overall brightness across the light exit surface of a light conductive plate.

In order to achieve the object described above, according to an aspect of the present invention, there is provided a spread illuminating apparatus of side light type, which includes: a light conductive plate defining a side surface as a light entrance surface, a first major surface as a light exit surface, and a second major surface opposite to the first major surface; a plurality of point light sources disposed at the side surface of the light conductive plate, wherein lights emitted from the point light sources are introduced into the light conductive plate from the side surface and exit out the light conductive plate from the first major surface; a light reflecting sheet disposed at at least one of the first major surface and the second major surface so as to cover a portion of the light conductive plate located close to the side surface and also the point light sources; and a plurality of light diffusing portions disposed at the light reflecting sheet and located so as to cover the point light sources, respectively.

With the light reflecting sheet (constituted, for example, by a white resin) disposed so as to cover the area of the light conductive plate close to the light entrance surface, leakage lights from the upper sides of the point light sources are reflected thereby into the light conductive plate thus efficiently utilizing the lights from the point light sources and consequently enhancing the brightness of lights emitted from the light exit surface of the light conductive plate. Also, since the light diffusing portions are disposed at the light reflecting sheet so as to cover respective point light sources, lights emitted in the proximity of the point light sources are diffused thereby inhibiting brightness variation.

In the aspect of the present invention, the light diffusing portions may be each constituted by a prism array such that the ridge lines of prisms of the prim array extend orthogonally to the side surface of the light conductive plate, and such that the apexes of the prisms point toward the first major surface of the light conductive plate. With the structure described above, the lights emitted from the point light sources can be efficiently utilized.

And, in the aspect of the present invention, the light diffusing portions may be each constituted by a light diffusive member.

### BRIEF DESCRIPTION OF THE DRAWINGS

FIG. 1 is an exploded perspective view of a spread illuminating apparatus according to one embodiment of the present invention, and an LCD device to be illuminated by the spread illuminating apparatus;

FIG. 2 is a perspective view of prism arrays formed at a light entrance surface of a light conductive plate of the spread illuminating apparatus of FIG. 1;

FIG. 3 is an explanatory plan view of a light reflecting sheet provided at a light exit surface of the light conductive plate of the spread illuminating apparatus of FIG. 1;

FIG. 4 is an enlarged schematic perspective view of one exemplar of light diffusing portions provided at the light reflecting sheet in the spread illuminating apparatus of FIG. 1; and

FIG. 5 is another enlarged schematic perspective view of the light diffusing portions of FIG. 4 seen from a different angle for showing positional relationship of the light reflecting sheet with respect to the light conductive plate, and for better showing the light diffusing portions.

### DETAILED DESCRIPTION OF THE INVENTION

An exemplary embodiment of the present invention will be described with reference to the accompanying drawings.

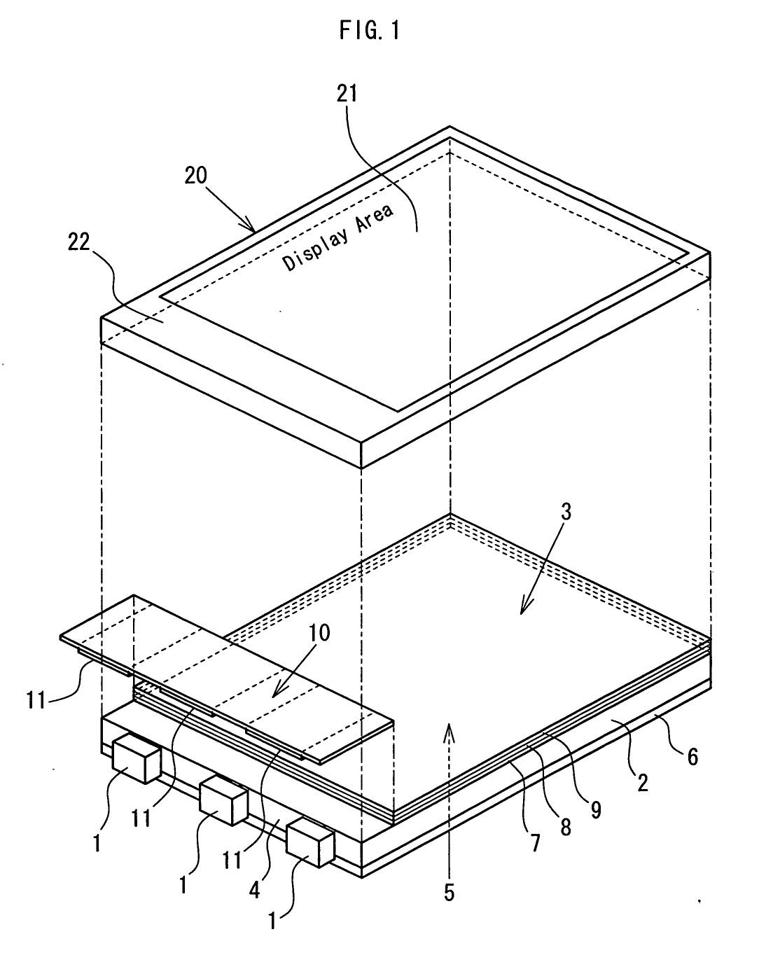

Referring to FIG. 1, a spread illuminating apparatus according to one embodiment of the present invention includes a light conductive plate 2, and a plurality (three in the figure) of point light sources 1 disposed at a side surface 4 of the light conductive plate 2. Lights emitted from the point light sources 1 are introduced into the light conductive plate 2 from the side surface 4 (referred to as a light entrance surface as appropriate) and exit out the light conductive plate 2 from an upper major surface 3 (referred to as a light exit surface as appropriate) so as to be emitted toward an object 20 to be illuminated (for example, an LCD device in the present embodiment, and hereinafter referred to as “LCD device”). The point light sources 1 may be each constituted, for example, by an LED which includes an LED chip disposed in an enclosure which has one open side to allow light from the LED chip to be efficiently emitted in one direction. The side of the LED chip corresponding to the open side of the enclosure is defined and referred to as “front side” as appropriate. The point light sources (LEDs) 1 are disposed with the front sides facing the light entrance surface 4 of the light conductive plate 2. Lights emitted from the LEDs 1 typically travel in the front side direction so as to efficiently fall incident on the light entrance surface 4 as effective light but partly travel in the upper, lower, right and left side directions as leakage light.

The light conductive plate 2 is formed of a material having an excellent transparency, such as polycarbonate, polyester, polymethylmethacrylate, and glass. A light reflecting pattern (not shown) is formed at a lower major surface 5 (referred to as a bottom surface as appropriate) of the light conductive plate 2 opposite to the light exit surface 3, so that the lights introduced into the light conductive plate 2 can exit out the light conductive plate 2 uniformly from across the light exit surface 3.

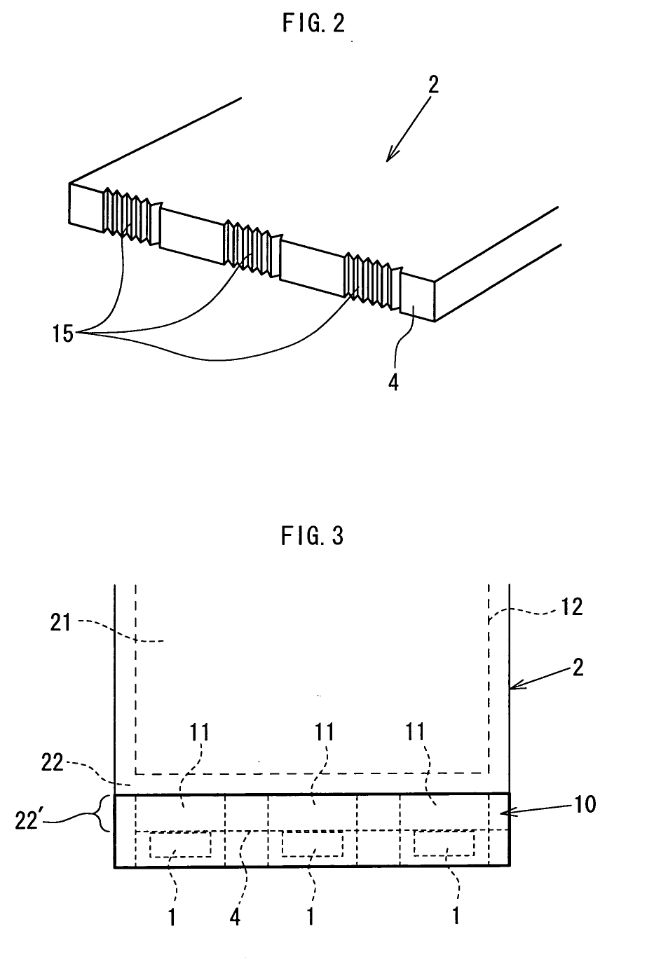

Referring to FIG. 2, prism arrays 15 each having prisms extending in the thickness direction of the light conductive plate 2 are formed at the light entrance surface 4 of the light conductive plate 2. The prism arrays 15 are formed separately from one another in a number equal to the number of the LEDs 1 such that the prism arrays 15 correspond in position and dimension (particularly width) to respective LEDs 1, but may alternatively be formed continuously without interruption in-between (not illustrated). The prism arrays 15 contribute to improving the overall brightness distribution across the light exit surface 3, but the spread illuminating apparatus incorporating the light conductive plate 2 with the prism arrays 15 is still not free from the brightness variation problem which is present between the areas located in the front side directions of the LEDs 1 and the areas located between adjacent LEDs 1, and a solution for which will be described later.

Referring back to FIG. 1, a light reflecting plate 6 is disposed at the bottom surface 5 of the light conductive plate 2. The light reflecting plate 6 is formed of a light reflective material, such as a white resin and a silver-plated film, and reflects light exiting out the light conductive plate 2 from the bottom surface 5 back into the light conductive plate 2. The light reflecting plate 6 is not limited to the structure described above, and may be structured such that a housing frame, which is formed of a liquid crystalline polymer, or like material, and which holds together constituent components of the spread illuminating apparatus, is adapted to collaterally perform a light reflecting function thus substituting the light reflecting plate 6.

A light diffusing sheet 7 is disposed at the light exit surface 3 of the light conductive plate 2. The light diffusing sheet 7 diffuses light so that a viewer is not allowed to perceive the configuration of an optical pattern, for example the aforementioned light reflecting pattern (not shown) formed at the bottom surface 5 of the light conductive plate 2. The light diffusing sheet 7 is formed of a transparent resin, such as polycarbonate, polyester, and polymethylmethacrylate, and has a thickness of 10 μm or more, preferably 20 to 300 μm. The light diffusing sheet 7 may be processed by mixing a light diffusing agent in the transparent resin or by randomly roughening the sheet surface.

Brightness enhancement films (BEF) 8 and 9 are disposed on the light diffusing sheet 7. The BEFs 8 and 9 are optical films formed of a highly transparent material, such as polyester resin, and acrylic resin, and having a precise prism pattern on the surface. With the BEFs 8 and 9 disposed over the light exit surface 3 of the light conductive plate 2, the brightness of light to be emitted to the LCD device 20 can be enhanced. If the BEFs 8 and 9 are oriented such that their respective prism pattern directions cross orthogonally to each other, then the performance and effect improve further so that image blurring is eliminated, and a stripe pattern (moire pattern) generated by brilliant and dark areas resulting from light diffusion is inhibited.

A light reflecting sheet 10 is disposed at the light exit surface 3 of the light conductive plate 2 so as to cover an area of the light exit surface located close to the light entrance surface 4 and also the upper sides of the LEDs 1. The light reflecting sheet 10 has a rectangular shape, and its longitudinal dimension is set equal to the width of the light conductive plate 2 so that the above-described area close to the light entrance surface 4 can be fully covered from one end to the other. A plurality of light diffusing portions 11 are provided at a surface of the light reflecting sheet 10 facing the light exit surface 3 of the light conductive plate 2. The light diffusing portions 11 correspond in number and position to the LEDs 1 so as to cover the upper sides of respective LEDs 1. The light diffusing sheet 10 will be detailed hereinlater.

The LCD device 20 is disposed over the light exit surface 3 of the light conductive plate 2, on which the light diffusing sheet 7, the BEFs 8 and 9, and the light reflecting sheet 10 are disposed. The LCD device 20 includes a display area 21 which is composed of LCD elements, and a non-display area 22 which surrounds the display area 21 and does not contain LCD elements. The LCD device 20 is what is called a backlight type display device, in which the back side of the display area 21 is illuminated by light emitted from the light exit surface 3 of the light conductive plate 2. With the spread illuminating apparatus described above, the LCD device 20 can be brightly illuminated, and the visibility is enhanced.

Referring to FIG. 3, the LEDs 1 disposed close to the light entrance surface 4 of the light conductive plate 2 are indicated by dashed lines, and the boundary between the display area 21 and the non-display area 22 of the LCD device 20 is indicated by a dashed line 12. As described above, the light reflecting sheet 10 is disposed at the light exit surface 3 of the light conductive plate 2, and covers the area located close to the light entrance surface 4 and running the entire width of the light conductive plate 2, and covers also the upper sides of the LEDs 1. The aforementioned area of the light conductive plate 2 positioned close to the light entrance surface 4 corresponds to a part of the non-display area 22, the part being indicated by numeral 22′ (referred to as an LED-proximate non-display area). The light reflecting sheet 10 is sized and positioned so as to cover the peripheral areas of the LEDs 1 as well as the upper sides thereof. The light reflecting sheet 10 is fixedly attached by means of claws formed at a housing frame (not shown) for the light conductive plate 2 or for the spread illuminating apparatus, but may alternatively be fixed by means of an adhesive tape, and like method.

The light reflecting sheet 10 is formed of a highly respective white resin and is disposed at the position described above thereby reflecting lights leaking from the upper sides of the LEDs 1 into the light conductive plate 2 thus efficiently utilizing lights from the LEDs 1, which results in enhancing the brightness of lights emitted from the light exit surface 3 of the light conductive plate 2, and eventually improving the brightness of the LCD device 20.

The light reflecting sheet 10 in the present embodiment has a rectangular shape but is not limited to this shape arrangement, and may be selectively formed, depending on the configuration of the light conductive plate 2 and on the configuration and arrangement of the LEDs 1 (or any type point light sources), in any optimal shape, for example, oval, circle, and square so as to efficiently reflect lights emitted from the LEDs 1. Also, the light reflecting sheet 10 in the present embodiment is disposed on the upper sides of the LEDs 1, that is, the light exit surface 3 of the light conductive plate 2, but may alternatively be disposed on the lower sides of the LEDs 1, that is, the bottom surface 5 of the light conductive plate 2, or on both the upper and lower sides of the LEDs 1, that is, both the light exit surface 3 and the bottom surface 5, whereby the same advantages can be achieved.

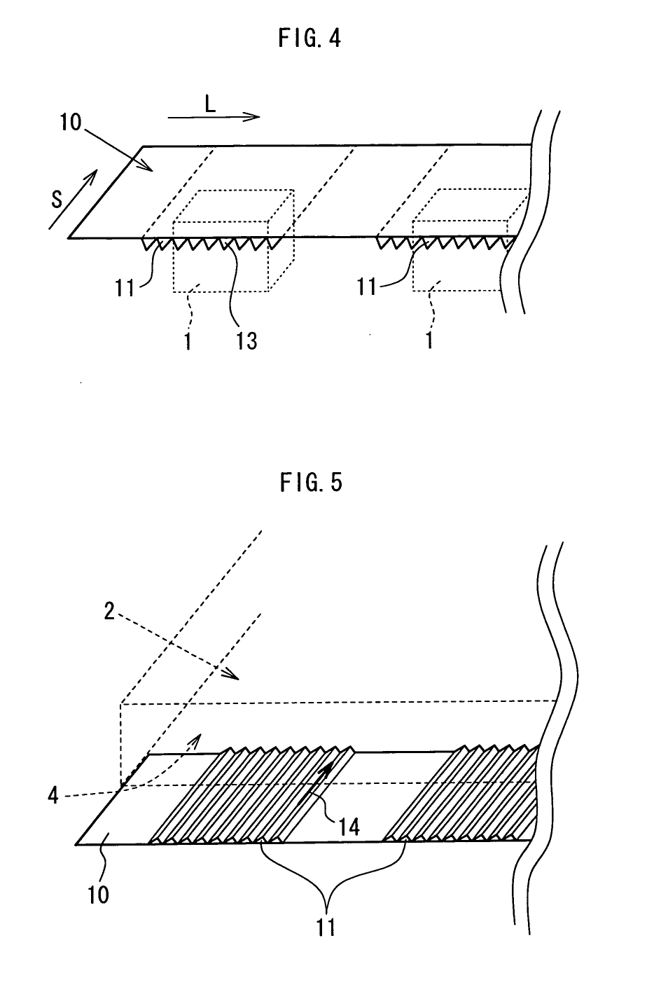

The light diffusing portions 11 provided at the light reflecting sheet 10 will be described with reference to FIGS. 4 and 5. In FIG. 4 the LEDs 1 are indicated by dashed lines, and in FIG. 5 the light conductive plate 2 is indicated by dashed lines.

Referring to FIG. 4, the light diffusing portions 11 are disposed so as to cover the upper sides of respective LEDs 1. The dimension of each light diffusing portion 11 extending in the direction S is equal to the width of the light reflecting sheet 10, the dimension thereof extending in the direction L is larger than the width of the LED 1, and consequently the light diffusing portion 11 has a larger area than the upper side of the LED 1. Thus, the light diffusing portion 11 is sized and located so as to cover not only the upper side of the LED 1 but also the peripheral area thereof. The light diffusing portions 11 are fixedly attached to the light reflecting sheet 10 by an adhesive, but the present invention is not limited to this structure and the light diffusing portions 11 may be integrally formed on the light reflecting sheet 10.

The light diffusing portions 11 are, for example, prism sheets each composed of a plurality prisms each having a triangular cross-sectional shape. Apexes 13 of the prisms of each prism sheet point toward the upper side of the LED 1 and the light exit surface 3 of the light conductive plate 2, ridge lines (refer to an arrow 14 in FIG. 5) of the prisms extend orthogonally to the light entrance surface 4 of the light conductive plate 2, the angles of the apexes 13 are 90 degrees, and the distance (prism pitch) between the apexes 13 of two adjacent prisms is about 25 μm. In this connection, the angles of the apexes 13 may be set to vary from one another, for example, such that the angles of the apexes 13 are 90 degrees at the center area of the light diffusing portion 11 and become larger with an increase in distance from the center area toward the both end areas. Also, the pointing direction of the apex 13 and the angle of the ridge line (14) with respect to the light entrance surface 4 may be set to vary from the center area to the end areas.

With the light diffusing portions 11 structured as described above, lights leaking from the upper sides of the LEDs 1 are diffused by the prisms in the longitudinal direction of the light reflecting sheet 10, whereby the brightness variation, which conventionally occurs at the area of the display area 21 near the LED-proximate non-display area 22′ due to the combination of the bright areas at the front sides of the LEDs 1 and the dark areas between adjacent LEDs 1, can be prevented, and at the same time the lights can be efficiently utilized so as to entirely enhance the brightness of the lights from the light exit surface 3 of the light conductive plate 2.

Though not illustrated, the light diffusing portions 11 may alternatively be constituted by light diffusive members, for example, light diffusing sheets. In this case, the light diffusive members preferably have a haze value of 80% or higher, and a total light transmittance of 90% or higher. With the light diffusing portions 11 constituted by the light diffusive members described above, the same advantages (prevention of brightness variation, and efficient utilization of lights for enhanced brightness) as described above can be achieved.

For example, when the light conductive plate 2 has a dimension of 35 mm×45 mm, and the LED 1 has a width (dimension in the direction L in FIG. 4) of 3 mm, it is preferable that the light reflecting sheet 10 preferably has a dimension of 35 mm×6 mm, and the light diffusing portions 11 each have a dimension of 5 mm×6 mm. It has been verified by experiments that the light diffusing portions 11 described above are equally effective in correcting the brightness variation occurring in the proximity of LEDs 1 as compared to the light reflecting and absorbing sheet conventionally used, and also that the average brightness across the entire light exit surface of a light conductive plate is enhanced, as compared to the light reflecting and absorbing sheet, by 3.5% when the light diffusing portions 11 are constituted by prism sheets, and by 3.1% when the light diffusing portions 11 are constituted by light diffusing sheets (haze value: 87%, and total light transmittance: 99%).

In the embodiment described above, the light reflecting sheet 10 is a discrete component with a size and shape adapted to cover the LEDs 1 and a part of the light conductive plate 2, but the present invention is not limited to such an arrangement and the light reflecting sheet 10 may be formed integrally with the light diffusing sheet 7 so as to cover the upper sides of the LEDs 1. In this case, the light diffusing sheet 7 may be sized to cover the upper sides of the LEDs 1 as well, and a portion of the light diffusing sheet 7 corresponding to the light reflecting sheet 10 may be coated white by printing, whereby the light diffusing sheet 7 and the light reflecting sheet 10 can be easily integrated into one component. Also, the light diffusing portions 11 may be structured such that the BEFs 8 and 9 are partly extended to the shapes of the light diffusing portions 11 so as to cover the upper sides of the LEDs 1 and their peripheral areas, thus substituting the light diffusing portions 11. With the light diffusing portions 11 structured as described above, the same advantages (prevention of brightness variation, and efficient utilization of lights for enhanced brightness) as described above can be achieved.

Thus, the spread illuminating apparatus according to the present invention achieves a uniform brightness across the light exit surface 3 of the light conductive plate 2 including the areas close to the LEDs 1 and therefore can be suitably used as an illumination means (backlight device) for the LCD device 20. And, the dimension of the non-display area 22 positioned toward the LEDs 1 can be reduced thereby increasing the dimension of the display area 21 of the LCD device 20 while maintaining its outside dimension.

The preceding description has been presented only to illustrate and describe the invention. It is not intended to be exhaustive or to limit the invention to any precise form disclosed. Many modifications and variations are possible in light of the above teaching. The exemplar embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A spread illuminating apparatus of side light type, comprising:
a light conductive plate defining a side surface as a light entrance surface, a first major surface as a light exit surface, and a second major surface opposite to the first major surface;
a plurality of point light sources disposed at the side surface of the light conductive plate, wherein lights emitted from the point light sources are introduced into the light conductive plate from the side surface and exit out the light conductive plate from the first major surface;
a light reflecting sheet disposed at at least one of the first major surface and the second major surface so as to cover a portion of the light conductive plate located close to the side surface and also the point light sources; and
a plurality of light diffusing portions disposed at the light reflecting sheet and located so as to cover the point light sources, respectively.

2. A spread illuminating apparatus according to claim 1, wherein the light diffusing portions are each constituted by a prism array.

3. A spread illuminating apparatus according to claim 2, wherein ridge lines of prisms constituting the prim array extend orthogonally to the side surface of the light conductive plate.

4. A spread illuminating apparatus according to claim 2, wherein apexes of prisms constituting the prism array point toward the first major surface of the light conductive plate.

5. A spread illuminating apparatus according to claim 1, wherein the light diffusing portions are each constituted by a light diffusive member.
